(19) United States
(12) Patent Application Publication
(10) Pub. No.: US 2005/0178079 A1
(43) Pub. Date: Aug. 18, 2005

(54) Modular insert fenestration system

(76) Inventors: Barry G. Hardman, Temecula, CA (US); James Dean Katsaros, Midlothian, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/049,773

(22) Filed: Feb. 3, 2005

Related U.S. Application Data
(60) Provisional application No. 60/544,703, filed on Feb. 13, 2004.

(51) Int. Cl. E04B 2/00; E04F 13/00; E06B 3/00; E06B 3/964

(52) U.S. Cl. 52/208; 156/71; 52/204.5; 52/204.62

(57) ABSTRACT

A device for installation in an opening in a structure, wherein the device is made of a receptacle and a fenestration product and the receptacle is adapted for substantially permanent installation in the opening by securing to the opening and wherein the receptacle is adapted to match with the fenestration product for installation in the receptacle such that moisture intrusion into the structure is prevented.

### BACKGROUND OF THE INVENTION

1. Field of the Invention

This invention is directed to a system and method for preventing air and moisture intrusion at openings in structures, such as buildings, which contain fenestration products, such as windows, doors and the like.

2. Description of the Related Art

Moisture intrusion around fenestration products (windows, doors, skylights, vents, utility supply boxes, and other items that are made to fit into openings in structures, such as buildings) is one of the primary sources for moisture damage, such as mold and rot, in buildings. Hereafter, for the sake of convenience the term “window(s)” will be used to refer to the various aforementioned fenestration products. Currently, there are various methods for controlling this moisture intrusion, with numerous flashing, window design, and installation methods being used with varying degrees of success. Conventional methods or systems are limited to the removal of water once it is inside the wall, as opposed to the prevention of water getting into the wall at the interface of the window and wall. Mechanical sill pans are often prescribed to direct water that enters through a leak at the window or window-wall interface to the exterior of the building, but it is very difficult to achieve a continuously integrated air/moisture seal between the sill pans and the fenestration product, particularly one that is effective for all types of designs and shapes of fenestration products and openings.

Also, the current methods for installation make it very difficult and expensive to replace the window if it fails (e.g., leaks) or if improved or different functionality is desired (such as, better radiation blockage, energy insulation, self-cleaning, etc). Thus, the window is currently considered a permanent “fixture” in the building wall, although these products typically do not maintain their performance over the life of the building structure.

### BRIEF DESCRIPTION OF THE DRAWINGS

FIG. 1 is a schematic view of a receptacle that can be positioned in an opening in a structure.

FIG. 2 is a schematic cross sectional view of FIG. 1.

FIG. 3 is a side view of FIG. 1.

FIG. 4 is a schematic cross sectional view of the receptacle of FIG. 2 with a window positioned in the receptacle.

FIG. 5 is a schematic cross sectional view of another embodiment of a receptacle with a window positioned in the receptacle.

FIG. 6 is a schematic view of a wall panel incorporating a plurality of receptacles.

FIG. 7 is a side view of yet another embodiment of a receptacle.

FIG. 8 is a side view of the receptacle of FIG. 7 with a window positioned in the receptacle.

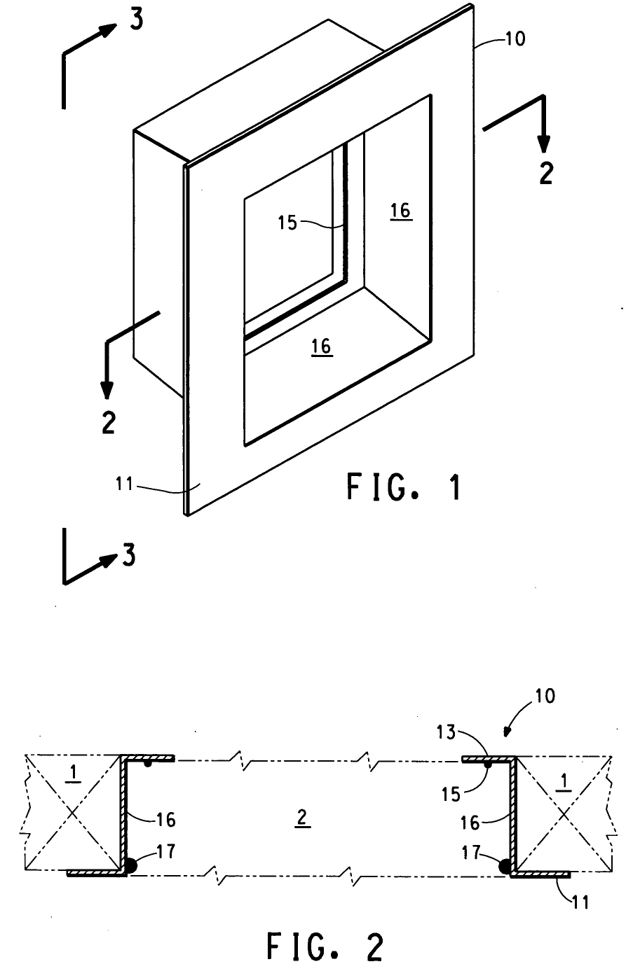

### DETAILED DESCRIPTION OF THE INVENTION

In the past decade, an extraordinary number of building defects have been identified that are a result of water intrusion into and beyond the face of the building structure or weather-resistant barriers. One of the major areas of water intrusion is the interface between fenestration products and the openings in buildings into which the products fit. Fenestration products are windows, doors, skylights, vents, utility supply boxes, and other items that are made to fit into openings in structures, such as buildings. It should be recognized that structures are not limited to buildings and may encompass anything having an opening wherein a fenestration product could be placed such as a boat or recreational vehicle, etc. Hereafter, for the sake of convenience the term “window(s)” will be used to refer to the various aforementioned fenestration products. A device has been developed to overcome these problems and comprises a receptacle and a window that will provide a greatly simplified modular-type method to install windows in a standardized fashion that will result in a very effective barrier to air and moisture intrusion. The receptacle is placed such that it is closely fit into the opening in the building structure or sealed to the weather-resistant barriers that cover the wall panels. The receptacle not only acts as a fixture to hold the window, it isolates the windows from the membrane drainage planes of the building envelope and the cladding. Currently, if a window leaks at its corner joinery, there is no practical way to drain the leakage from the interior cavity to the exterior of the cladding on the building. This receptacle accomplishes this important task, while at the same time enhancing the performance of the window in the wall.

The receptacle of this invention will prevent surface water on walls, claddings, and weather-resistant barriers from entering through the walls or wall cavities via cracks and joints in the interface caused by the installation of a window penetrating through the weather-resistant barrier or drainage plane. This system terminates and seals the weather-resistant barrier/membrane/drainage plane to the receptacle, isolating the fenestration product from this interface. Water is therefore stopped from entering behind the membrane or into the wall cavity because the receptacle is sealed directly to the wall or weather-resistant membrane, rather than to the window. The receptacle will capture any leaks through the window itself and the moisture will be isolated from the window and the building structure and drained to the exterior of the building through appropriately provided drainage paths. This replaces or obviates the need for sill pans or end dams.

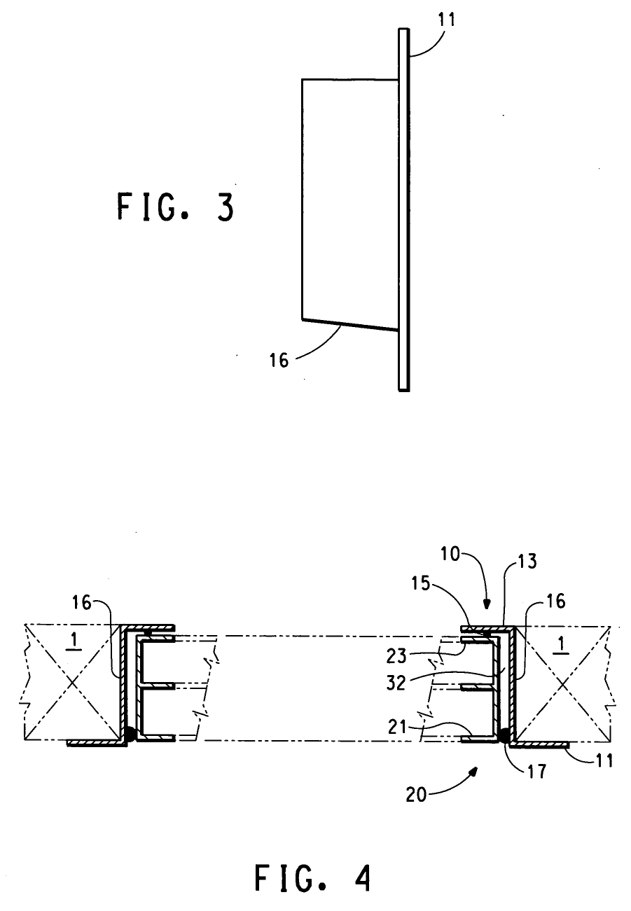

The invention will be described by reference to the figures attached hereto. As shown in FIG. 2, receptacle 10 is made to fit into an opening 2 in building wall 1. Receptacle 10 is comprised of four adjoining walls (top, sides and bottom) 16, and exterior flange 11. The receptacle can be made from separate pieces that can be joined together or it can be made as a unitary structure by molding or some other suitable forming process. Walls 16 are adapted to fit snugly into opening 2. If the shape of the opening were other than four-sided as depicted, the shape of the walls 16 would correspond to the shape of the opening. For example, if the opening were circular, walls 16 would be instead a tubular structure. As shown in FIG. 4, the window 20 is made to fit into the receptacle 10 and the window is held in place by a mechanical locking means, such as a clamp, (not shown) that can be provided to connect the interior flange 13 of the receptacle and interior sash 23 of the window. In this manner, the receptacle and window can be held in place without the use of through-fasteners. If the fenestration product were something other than a window, the mechanical locking means would attach to an appropriate surface, such as a flange or lip rather than to a sash. When the receptacle is first placed in the opening, an interior sealing means 15 will be positioned on the interior flange 13. An exterior sealing means 17 will be placed between the receptacle and the window at an exterior location as generally depicted in FIG. 2. The sealing means 15 or 17 can be made from a durable foam or gasket material, or other suitable material. During installation of the window into the receptacle, sealing means 15 can be alternatively positioned on the interior sash 23 of the window. Regardless of where it is initially placed, sealing means 15 will provide a seal between the innermost surface of window 20 and receptacle 10 as depicted in FIG. 4. By sealing the window to the receptacle with sealing means 15 and 17, a chamber 32 is created between the window and the receptacle and becomes pressure-equalized with the exterior of the structure when openings are provided near the lower corners of chamber 32, between the bottom of the window and the receptacle. The openings in the lower corners of chamber 32 also provide drainage paths for any moisture that may collect in the chamber. Alternatively, appropriately placed weep holes (not shown) can be used in the same manner as the openings. The bottom or floor portion 16 of the receptacle is preferably angled downwardly from the interior to the exterior, as shown in FIG. 3, to provide for drainage of moisture that may collect in the receptacle to the drainage paths. The chamber 32 preferably measures about one-fourth inch between the fenestration product and the receptacle to provide isolation of the fenestration product from the receptacle and the wall and to provide moisture clearance and thermal bridging.

Alternatively, through-fasteners can be used to attach the receptacle to the window. For example, screws can be installed through the exterior of the receptacle into the window, at a 90° angle to the wall. Any puncturing of the sill portion would have to be sealed. In another embodiment, spring knife clips can be installed to hold the window against the seal at the rear of the receptacle. The use of spring clips allows the window to be easily disengaged from the receptacle, by using a knife or other simple releasing tool. In another embodiment, a screw-fluted wedge can be installed to cut into both the window and the receptacle. In another embodiment, the key-like mechanism having shaped protrusions can be used to twist into like-shaped grooves on either the receptacle or the window or both. In another embodiment, a series of jackscrews can be used that when tightened would force the window against the receptacle. Other embodiments include the use of pins, dead bolts, slide bolts, and cams to secure the window to the receptacle. Keyed access may be installed with a cylinder and a key raceway to limit access.

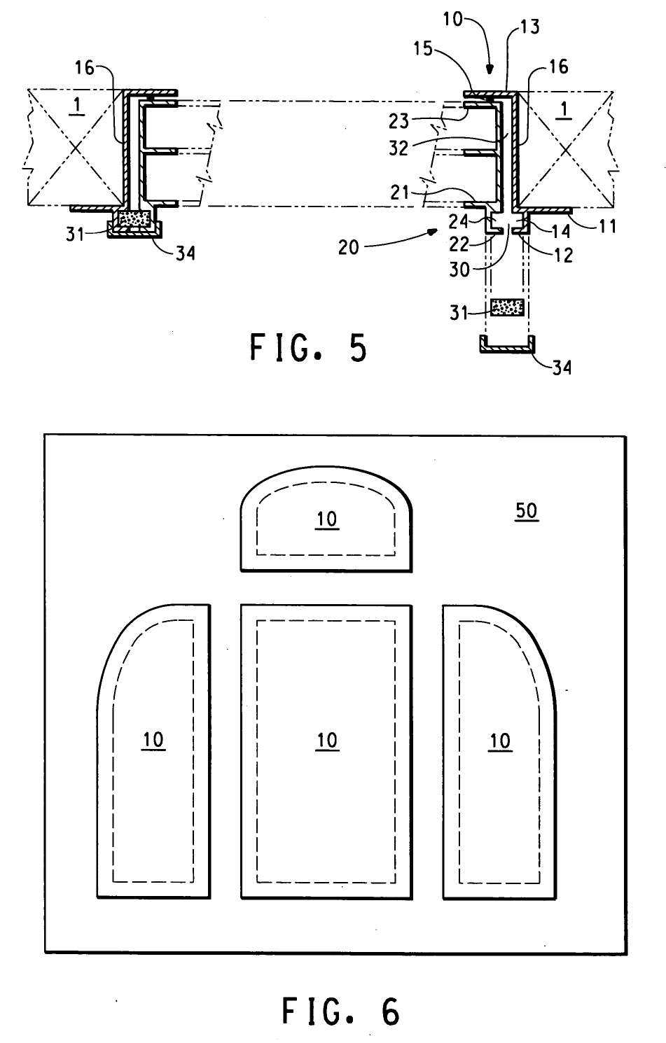

In another embodiment as shown in FIG. 5, receptacle 10 contains a continuous channel 14 that extends around all four sides, which is formed by exterior flange 11 and receptacle flange lip 12. The window 20 also contains a matching continuous channel 24 on all four sides that is formed by exterior flange sash 21 and window flange lip 22. Channels 14 and 24 of the receptacle and the window, respectively, are formed to mate as shown in FIG. 5 to form a partially open cavity 30. The partial opening in cavity 30 permits the insertion of a sealing/locking means 31 into the cavity 30, which holds the receptacle and window in place without the use of through-fasteners. The sealing/holding means can be a compressible material, such as a gasket made of rubber or foam, or some other suitable material, such as a sealing compound. Optionally, a cap 34 can be used to cover the sealing/holding means to provide protection from environmental exposure of the cavity 30 and sealant 31, such as from ultraviolet rays, as well as to enhance the appearance of the device. Optionally, a mechanical locking means (not shown) such as a clamp can be provided to lock the interior flange 13 of the receptacle and interior sash 23 of the window.

When the receptacle is first placed in the opening, an interior sealing means 15 will be positioned on the interior flange 13. The interior sealing means 15 can be made from a durable foam or gasket material, or materials similar to those used for the sealing/locking means 31. Alternatively, during installation of the window into the receptacle, sealing means 15 can be positioned on the interior sash 23 of the window. Regardless of where it is initially placed, sealing means 15 will provide a seal between the innermost surface of window 20 and receptacle 10 as depicted in FIG. 5. By sealing the window to the receptacle at this rear location, the chamber 32 created between the window and the receptacle becomes pressure-equalized with the exterior of the structure when openings are provided in the lower corners of channel 14 (below the sealing locking means). The openings also provide a drainage path for any moisture that may collect in the chamber 32 and flow out via cavity 30. As such, care should be taken when sealing cavity 30 not to inhibit the flow of moisture through the cavity. When the cavity becomes pressure-equalized, cavity pressure and the exterior pressures are equalized, thus allowing uninhibited, non-pressure-resistant water drainage to the exterior of the receptacle. Alternatively, appropriately placed weep holes (not shown) can be used in the same manner as the openings.

The receptacle is permanently affixed to an opening in the wall construction and sealed to the wall and/or the weather resistant membrane that covers the walls of the building. The receptacle can be affixed with adhesives, fasteners, and the like. Because the window is connected to the receptacle by the use of a removable sealing/locking means, the window (or other through-wall devices) can be removed relatively easily from the building without causing destruction to the membranes and claddings. A security-locking device (not shown) can be installed on the receptacle to prevent theft of the window or unauthorized entry to the building and would be preferably located toward the interior of the opening. Although windows have relatively long life, their life is shorter than that of the building. As such, when replacement of a window is desired or necessary, the removal and replacement will entail minimal labor cost, because the wall would not be damaged during removal. This would particularly simplify replacement of existing windows with those having state-of-the-art characteristics, such as sophisticated glass configurations that have enhanced energy efficiency, sound attenuation, self-cleaning features, or light control, etc.

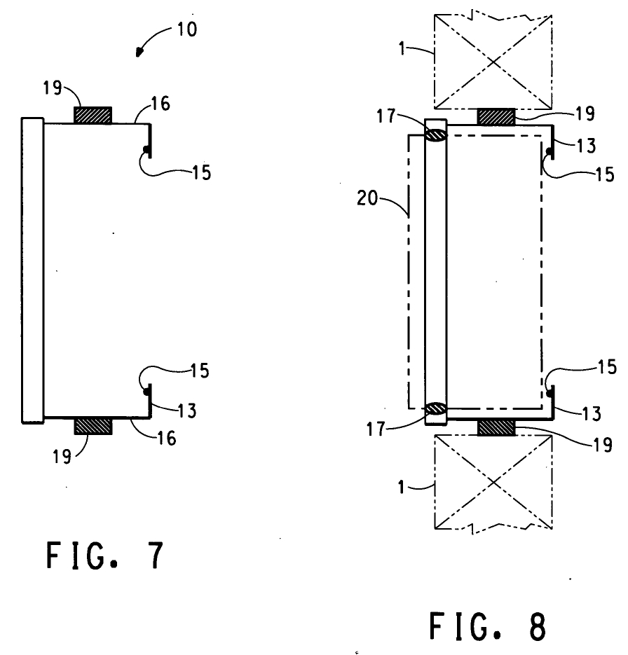

The receptacle would typically be installed from the outside of the building with the receptacle flange 11 resting on the exterior face of the structure. However in some instances, such as when replacing an existing window in a structure that has existing siding that is difficult or expensive to remove, such as brick or stone that is flush with the window, it would be inconvenient or expensive to remove this siding in order to install the receptacle with the flange 11 as shown. Thus, it would be helpful to install the receptacle without the flange protruding onto the external face of the structure. Retrofitting of an existing building would be one such situation. In such a case, an alternative embodiment is that the receptacle 10 has a gasket 19 extending around the outside as shown in FIG. 7 and can be inserted and sealed into the wall opening. Therefore, the sealing would be achieved by insertion of the gasket between the outside medial surfaces of the receptacle and the inside surfaces of the opening. The gasket can be made from rubber or any other suitable material. As in the previously described embodiments, a sealing means 17 would be used when the window is inserted into the receptacle as shown in FIG. 8. This embodiment of the receptacle can have the same configuration as shown in FIG. 2 or in FIG. 5 as an alternative. Means would be provided to tighten the receptacle to make an air/moisture seal against the surfaces of the opening in the structure. In order to achieve the tight seal, the receptacle would have to have some expansion capability, such as expandable couplings between sections of the receptacle with adjustable tightening screws. This embodiment would be especially suitable for high-rise buildings or retrofit jobs where installation of the receptacle from the inside of the building is desired.

There are, of course, a variety of sizes and shapes of windows that can be installed in buildings. For the receptacle to conform to such custom shapes, a molded wall panel 50 may be constructed having the same dimensions as typical sheathing boards, with one or more custom-shaped receptacles 10 molded, stamped, or otherwise formed integral with the wall panel as schematically depicted in FIG. 6, so that the receptacle and the wall panel are one piece. The wall panel could be constructed of a moldable plastic, such as a rigid, reinforced plastic, or some other material having similar properties. In another embodiment, one or more custom-shaped receptacles could be formed as an integral part of a conventionally used construction material, such as a sheathing board such that a separate wall panel would not be required.

Additionally, for irregular shaped fenestration products, the receptacle frame can be constructed of rigid pieces at the sill and lower jambs connected to a deformable, flexible material that can be conformed to fit around the irregular shape of the fenestration product, thereby providing a continuous enclosure. This would be useful for example with products having a round shape at the top, such as palladium windows. Such a conformable receptacle allows for improved fit and minimization of errors due to field tolerances between rough openings and fenestration products.

In another embodiment, substantially the entire receptacle could be made from a suitable material that could be sprayed on or otherwise applied to an opening in a liquid or semi-solid form, which would then solidify either by crosslinking (curing) or solvent evaporation into a receptacle capable of supporting the fenestration product. The fenestration product could be set into the receptacle material prior to or after the solidification occurs. Suitable receptacle materials for this embodiment include, but are not limited to, polyurethanes, epoxide derived polyethers, polyisocyanurates, polyureas, and acrylic polymer latexes. These could also include reinforcements and fillers such as fibers and particulates.

In a different embodiment, especially for rectangular (or square) windows, corner pieces could be formed by injection molding for example and then combined with straight extruded pieces of various lengths to form receptacles with the desired dimensions. These corner pieces could be connected to the straight pieces by a coupling means that maintained an air/moisture seal. This coupling means could also be designed to enable some movement in the receptacle to adapt to typical movement in the building opening, due to thermal expansion and/or seftling of the building. These products would typically be pre-fabricated and customized to the size and shape corresponding to the need of various window manufacturers. An additional concept is to make multiple insert receptacles in a forming process. For example, a plurality of receptacles could be formed in one mold. Seamless receptacles of various sizes and shapes could be formed, as applicable to individual construction designs without the need of complex corner pieces.

Current construction practices typically require several trades to be coordinated in installing windows or other units that penetrate the openings in building membranes. The responsibility for the interface between the membrane and the window is unclear presently and currently can change, depending upon the construction sequencing of either the window or the weather-resistive barriers and the cladding installations.

Because the membrane and claddings, as well as the receptacles, can be installed before the windows, the entire envelope and finishing of the exterior walls can be accomplished without the window in place, thus eliminating the need for special protection of the window during the construction period. Further, the interior wall claddings can be completely installed and finished without the window in place. This would avoid many of the disadvantages of the current procedures in construction of homes, such as glass breakage and the marring of windows with paint and drywall compound that must be cleaned off and eliminate the expense of protecting the windows during this phase of construction.

Because the window and the receptacle are effectively isolated from each other by the sealing/holding means and an asymmetrical design, it is believed that additional benefits are achieved through dampening. This dampening will assist in sound attenuation through the window-wall interface and will dampen the window itself. It is also believed that same benefit is realized from a thermal standpoint because the receptacle and the sealing/holding means will reduce the amount of energy that can transfer between the building interior and exterior.

Architectural design details often add surrounding trim to the window on the exterior side for aesthetic purposes. These members currently are fastened directly to the wall between the window and the cladding in most cases and occasionally on top of the cladding and next to the window. These two details require through-fastening, which penetrate the weather-resistive membranes, possibly causing leakage into the wall cavity. The receptacle can be designed in such a way as to incorporate a variety of trims onto the wall, which do not fasten through the wall, but can be attached to the receptacle without fasteners, by employing snap-on friction technology.

1. A device for installation in an opening in a structure comprising a receptacle and a fenestration product, wherein the receptacle is adapted for substantially permanent installation in the opening by securing to the opening and wherein the receptacle is adapted to match with the fenestration product for installation in the receptacle.

2. The device of claim 1, wherein upon installation of the fenestration product into the receptacle, application of an exterior sealing means and an interior sealing means forms a chamber that extends for the peripheral length of the device.

3. The device of claim 1, further comprising a clamping means positioned over an interior flange of the receptacle and an interior surface of the fenestration product.

4. The device of claim 2, wherein the interior and exterior sealing means are selected from the group consisting of a gasket, sprayed foam and sealing compound.

5. A device for installation in an opening in a structure comprising a receptacle and a fenestration product, wherein the receptacle is adapted for substantially permanent installation in the opening by securing to the opening and wherein the receptacle includes a channel located around the periphery of the receptacle adapted to match with a similar peripheral channel of the fenestration product for installation in the receptacle, wherein the channel of the receptacle and the channel of the fenestration product each have at least one flange lip.

6. The device of claim 5, wherein upon installation of the fenestration product into the frame, a partially open cavity that extends for the peripheral length of the device is provided by matching at least one flange lip of the channel of the receptacle with at least one flange lip of the fenestration product.

7. The device of claim 6, wherein a locking/sealing means is positioned in the partially open cavity.

8. The device of claim 5, further comprising a clamping means positioned over an interior flange of the receptacle and an interior surface of the fenestration product.

9. The device of claim 7, wherein the locking/sealing means is selected from the group consisting of a gasket, sprayed foam and sealing compound.

10. The device of claim 2 or 6, further comprising a drainage path.

11. The device of claim 1 or 5, further comprising a security locking means.

12. The device of claim 5, further comprising a cap for covering the matching legs of the channel of the receptacle and the channel of the fenestration product.

13. A wall panel comprising at least one integrated receptacle as described in claim 1 or claim 5.

14. A receptacle for installation in an opening in a structure adapted for substantially permanent installation in the opening and for receiving a fenestration product to form a modular unit.

15. The receptacle of claim 14, having a unitary construction.

16. The receptacle of claim 14, formed from a plurality of interconnecting members.

17. The receptacle of claim 14, formed by applying a curable material to at least one surface of the opening.

18. The receptacle of claim 17, wherein the curable material is selected from the group consisting of polyurethanes, epoxide-derived polyethers, polyisocyanurates, polyureas, and acrylic polymer latexes.

19. A fenestration product for installation into the receptacle of claim 14.

20. A method of installing a fenestration product into a structure, comprising the steps of:
a) providing a receptacle adapted for receiving a fenestration product;
b) inserting the receptacle into an opening in the structure;
c) providing a fenestration product adapted for insertion into the receptacle; and
d) inserting the fenestration product into the receptacle.

21. The method of claim 16, wherein the second inserting step comprises inserting a locking/sealing means between the receptacle and the fenestration product.
